(19) United States
(12) Patent Application Publication
(10) Pub. No.: US 2008/0091817 A1
(43) Pub. Date: Apr. 17, 2008

(54) Systems and methods for locating terrorists

(75) Inventor: Aris Mardirossian, Germantown, MD (US)

Correspondence Address: NIXON & VANDERHYE, PC, 901 NORTH GLEBE ROAD, 11TH FLOOR, ARLINGTON, VA, 22203, US

(73) Assignee: Technology Patents, LLC, Derwood, MD (US)

(21) Appl. No.: 11/546,560

(22) Filed: Oct. 12, 2006

(51) Int. Cl. G06F 15/173

(52) U.S. Cl. 709/224

(57) ABSTRACT

Systems and/or methods for locating and/or identifying individuals that use network-enabled client devices to access particular network resources are provided. In certain example embodiments, a system and/or method is provided wherein a software module (e.g. one or more worm(s)) is configured to be stored on a server device and transmitted to at least one client device connecting to the server device is provided. The software module may include logic to cause the client device to broadcast a signal comprising location and/or identification information associated with the client device. The software module may exploit one or more vulnerabilities of the client device to become stored thereon and/or to transmit the location and/or identification information, which may include, for example, a processor serial number of the client device, an embedded ID of the client device, components of the client device, GPS coordinates of the client device, a true IP address, and/or true routing information. This system may be helpful in locating terrorists who use Internet websites to transmit or broadcast terrorism related propaganda or the like.

### FIELD OF THE INVENTION

Certain example embodiments of this invention relate to systems and/or methods for locating and/or identifying individuals that use network-enabled client devices to access particular network resources. More particularly, in certain example embodiments of this invention, a system and/or method is provided wherein a worm is implanted into an online resource (e.g. a website, email server, etc.) such that it is transmitted to a client device connecting to the online resource, optionally based on certain predefined criteria. The worm may become active, causing the client device to emit an identification and/or homing signal so as to help locate the positions of terrorists and/or their computers.

### BACKGROUND AND SUMMARY OF EXAMPLE EMBODIMENTS OF THE INVENTION

This country currently is waging a war against terrorism. Terrorism typically involves, for example, violent acts by an inherently weaker party against a stronger opponent. Terrorist tactics attempt to create fear through actual damage and unpredictability, the latter of which seemingly magnifies the impact of each successful attack. Defending against terrorist attacks frequently is not efficacious because, for example, the public tends to focus only on successful attacks while viewing money invested in other (e.g. untested or unnoticed) countermeasures as wasted. The public typically does not perceive the preventative measures taken by authorities unless they fail. Thus, the cost of a failure is readily discernable, whereas any increased deterrent effects are difficult to measure.

Modern-day terrorists, e.g., suicide/homicide bombers, threaten our forward-deployed missions and forces, as well as civilians, as indicated by the U.S. embassy bombings in Kenya and Tanzania in 1998, the U.S.S. Cole bombing in Yemen, and frequent attacks on U.S. and Iraqi forces in Iraq. And the events of Sep. 11, 2001 evidenced that suicide attacks are not confined to the Middle East. As these examples indicate, the war is being waged on multiple, and different, fronts.

Yet, the war also is being waged in ways that do not involve armed conflict. Indeed, there is a large media component to the war on terrorism. Terrorists use various media channels to recruit new members, inspire fear, communicate in code, deliver ultimatums, etc. Often, a single message may serve more than one of these purposes. For example, a typical scenario involves a terrorist group kidnapping a hostage (e.g. civilian, contractor, news person, etc.). The hostage is video recorded and generally provides identifying information, and this is often shown on an Internet website or the like. The hostage then may be forced to make a demand on behalf of the terrorist group. Such demands have included complete withdrawal from conflict (e.g. in Iraq, Gaza, etc.), release of prisoners, ceased support for certain other countries, religious conversion, etc. The demands almost invariably are not met. Further video recordings have shown executions of hostages, often in extremely graphic detail. Another example is the showing of pictures or videos of terrorists on websites. Such images evoke strong emotions on both sides.

Other sorts of messages shown on websites may be more propaganda-oriented. Such messages often condemn the actions of the enemy and deliver to actual or would-be allies a message along the lines of“beware” because “the friend of my enemy is my enemy.” Such messages also enable terrorist groups to thumb their noses at their enemies' failed operations and flaunt their own successes. Still further, propaganda-oriented messages typically are designed to incite conflict and recruit others.

If these and/or other transmissions to media outlets could be traced, it may be possible locate the terrorists (or their computers) behind these transmissions. This may be helpful in reducing the amount of such information being transmitted in the first place, and/or in locating and/or identifying terrorists. Unfortunately, the receptivity to these and other kinds of messages on the part of some traditional media outlets makes it possible for terrorists to disseminate the same. Al-Jazeera has developed a reputation for broadcasting messages from terrorist groups over their channels. U.S. media outlets have, on occasion, picked up and broadcast such messages, in whole or in part, either directly from the source or from Al-Jazeera broadcasts. Even when domestic media outlets redact portions of the message, the fact that a message has been conveyed often is enough to accomplish one or more purposes of a terrorist organization.

Furthermore, the availability of more and more media outlets simplifies this process yet further. For example, one typical way of using a media outlet to deliver a message on behalf of a terrorist group involves uploading or emailing a digitized video recording for broadcast or publication. Numerous websites on the Internet have been created to syndicate such recordings.

FIG. 1 is an illustrative network arrangement showing client devices communicating with server devices through the Internet in the prior art. The client side 110 includes a number of network-enabled (e.g. web-enabled) client devices 112a-d which are configured to communicate with server devices 122a-c in the server side 120 through the Internet 130. In general, the client devices 112a-d may be personal computers, laptops, web-enabled cell phones, Blackberries, PDAs, etc. Typically, a client device 112 will log onto a server 122 to transmit (e.g. upload, email, etc.) a message. The client device may take steps to obfuscate its true identity and location. For example, firewalls, anonymizers, IP ghosting services, and the like (not shown) may be used to conceal, for example, IP addresses, IP routing information, computer IDs, etc. The firewalls, anonymizers, IP ghosting services, and the like may comprise software and/or physical layers of separation.

As such, it often is difficult to stop messages from being transmitted in the first place. It is similarly difficult to track client devices transmitting such information, even if a party controlling an associated server were willing, and wanted, to do so. Thus, it will be appreciated that there is a need for a system and/or method for locating and/or identifying terrorists and/or the client devices that they use to communicate or post things on the Internet.

Accordingly, in certain example embodiments, a method of locating and/or identifying terrorists that use at least one client device to access a server device via a network is provided. A software module may be stored on the server device. Connections between the server device and the at least one client device may be monitored. The software module may be transmitted to the at least one client device in dependence on a determination of whether the connection between the server device and the at least one client device matches predefined criteria. When the software module is received by the client device, the software module may be configured to cause the client device broadcast a signal comprising location and/or identification information.

In certain other example embodiments, a software module configured to be stored on a server device and transmitted to at least one client device connecting to the server device is provided. The software module may include logic to cause the client device to broadcast a signal comprising location and/or identification information associated with the client device. The software module may be a worm.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is an illustrative network arrangement showing client devices communicating with server devices through the Internet in the prior art;

FIG. 2 is an illustrative network arrangement where certain server devices have worms stored thereon, in accordance with an example embodiment;

FIG. 3 is an illustrative plan view of a network-enabled mobile device emitting a signal detectable by receivers located with certain monitored areas, in accordance with an example embodiment;

FIG. 4 is an illustrative flowchart showing a method of identifying and/or locating terrorists, in accordance with an example embodiment; and,

FIG. 5 is an illustrative flowchart showing another method of identifying and/or locating terrorists, in accordance with an example embodiment.

### DETAILED DESCRIPTION OF EXAMPLE EMBODIMENTS OF THE INVENTION

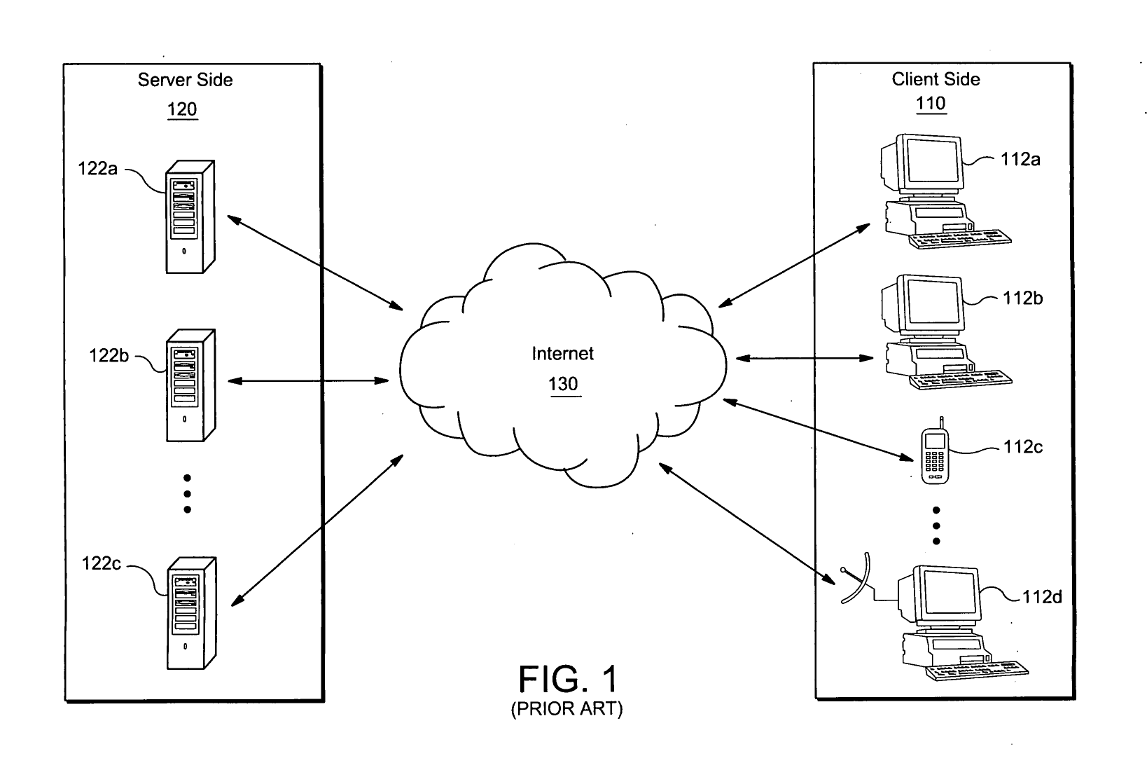

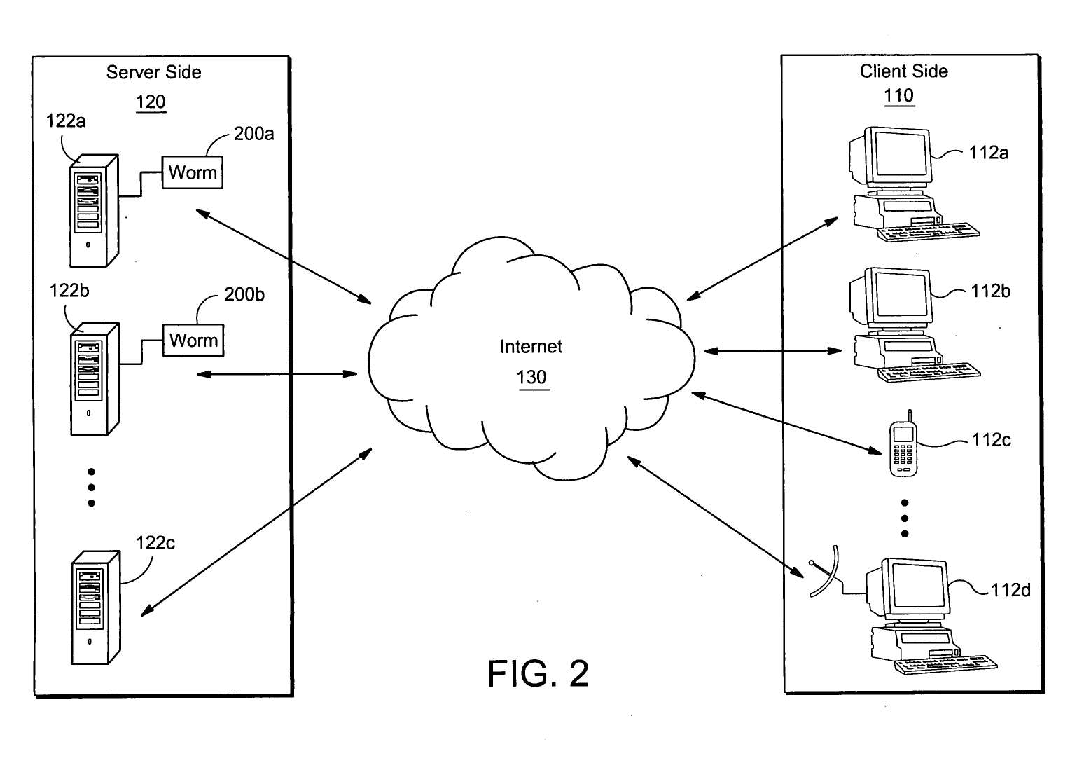

Referring now more particularly to the drawings in which like reference numerals indicate like parts throughout the several views, FIG. 2 is an illustrative network arrangement where certain server devices have worms stored thereon, in accordance with an example embodiment. FIG. 2 is like FIG. 1, in that the client side 110 includes a number of network-enabled (e.g. web-enabled) client devices 112a-d, which are configured to communicate with server devices 120a-c in the server side 120 through the Internet 130. Also like FIG. 1, a client device 112 will log onto a server 122 to transmit (e.g. upload, email, etc.) a message. However, certain server devices 122a-b have had worms 200a-b installed thereon. These worms 200a-b may transmit themselves to client devices using the connection between the client device and the corresponding server device.

More particularly, the worms may be intentionally implanted on servers by cooperating media groups. For example, a media group that is cooperative that typically receives messages from terrorist groups may allow the worms to be implanted on its server(s). However, worms may be surreptitiously implanted on the server(s) of media groups that are not cooperative. The worms may be small in size and difficult to detect, thus reducing the ease with which the media group and/or the terrorist group could detect the worm residing on a server or as being transmitted to the client device.

The worms need not be stored on every server. Indeed, it probably would be impossible to transmit the worm to every server with an Internet connection. Rather, known facilitators and attractive media channels make good candidates for worm implantation. Furthermore, it may even be possible to develop a site that is particularly attractive to terrorists seeking to transmit a message. Opening up channels that are particularly attractive to unscrupulous sources has been known to work, for example, in identifying, tracking, and stopping mail-bombers, spammers, etc. These techniques thus could be extended to make certain new or existing sites attractive to terrorist groups and to facilitate the transmission of worms by, for example, making it appear that there no username/password combination is required, usage logs are not kept, etc.

In certain example embodiments, the worms may be transmitted to all devices connecting to a server device having a worm. Alternatively, in certain other example embodiments, the worms may be transmitted to only those devices that meet a certain profile. For example, such worms need not be transmitted to the casual reader of CNN.com. Similarly, they may be targeted to IP addresses that originate and/or pass through a known gateway (e.g. a gateway in Iraq, a known portal for terrorist communiques, etc.).

The worm may be transmitted to the client device in a number of different ways. The following list of vulnerabilities should be taken by way of example and without limitation. It will be appreciated that other techniques may be used in place of, in addition to, the following list as new vulnerabilities are discovered and new patches are made available. Also, it may be advantageous to use more than one technique, as different systems will have vulnerabilities by virtue of, for example, the hardware, software, updates, etc. As one example, then, the worm may exploit one or more known vulnerabilities of a system and/or the software running thereon. On Unix and Linux machines, for example, vulnerabilities may exist in print and email server components of the kernel. On Windows machines, it may be possible to cause buffer overflows, cause email messages and/or ActiveX controls to be automatically received and executed, etc. In another example, the worm may be transmitted as one or more additional packets, or as parts of multiple packets transmitted to the client device 112.

In certain other example embodiments, one or more programs may be distributed such that they make the system amenable to the worms by functioning, for example, as backdoors, Trojans, or the like. Such functionality may be embedded, for example, in emailing programs, web browsers, ftp clients, etc. Widely distributed operating systems also may be modified to make the system amenable to attack.

Once a worm 200 is transmitted to a client device 112, it may cause an identification and/or location signal to be emitted from the client device 112. If the client device 112 is equipped with a GPS device, the exact coordinates may be transmitted via a web, email connection, or other suitable connection. Other information may include, for example, information identifying the computer with a predetermined degree of specificity (e.g. processor serial number, embedded ID numbers, particular components, etc.), the IP address of the connection, the route through which the transmissions are passing, etc.

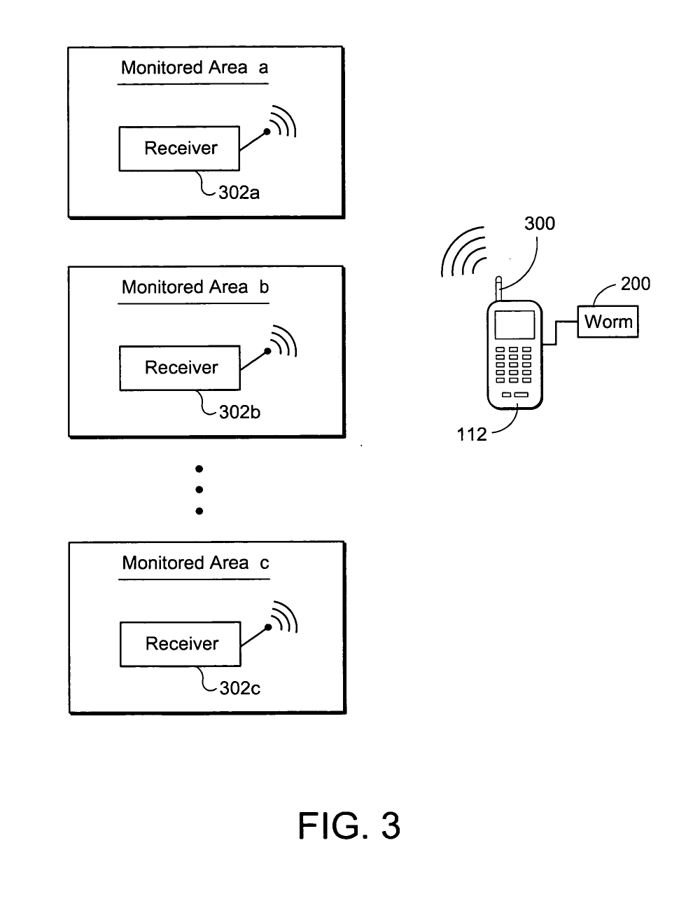

In certain example embodiments, if the client device is equipped with a wireless transmitter, a homing or identifying signal may be produced, indicating that the client device was used to transmit a message. FIG. 3 is an illustrative plan view of a network-enabled mobile device emitting a signal detectable by receivers located within certain monitored areas (e.g. airports, bus stations, subways, border crossings, random locations, etc.), in accordance with an example embodiment. In FIG. 3, a worm 200 has been transmitted to the client device 112. The worm 200 may cause the client device 112 to emit a signal via the wireless transmitter 300. If the client device 112 is used within one of the monitored areas a-c, a receiver 302a-c may receive the emitted signal. At this point, the user of the client device 112 may be located (e.g. by tracing the signal to its source, triangulation, etc.) and apprehended.

In certain example embodiments of this invention, the receivers 302 are located in monitored areas such as airports, train stations, bus stations, etc. because of the large number of people who pass through the same. Thus, when the monitoring receivers are located in such locations, it is possible to locate terrorists (or terrorist computers) which pass through such areas, even if the signal transmitted from the client device 112 is a low-powered signal which is not transmitted a great distance. FIG. 3 is an illustrative plan view of a network-enabled mobile device emitting a signal detectable by receivers located within, for example, one or more of airports, bus stations, subways, border crossings, random locations, etc. in accordance with an example embodiment. This permits the user of the client device 112, and/or the client device, to be detected in areas where security is present so that they may be quickly and efficiently apprehended.

In certain example embodiments, the wireless transmitter 300 of the mobile device 112 may emit a homing signal that may be picked up irrespective of whether the mobile device 112 is within a predefined monitored area. Thus, the user of the client device 112 may be located (e.g. by tracing the signal to its source, triangulation, etc.) and apprehended.

The above-described signals may be transmitted at a certain frequency, bandwidth, channel, etc. to serve as unique identifiers. Alternatively, the signals may be processed along common and/or active channels to appear merely as background noise. Moreover, they may incorporate certain predefined information, as described above.

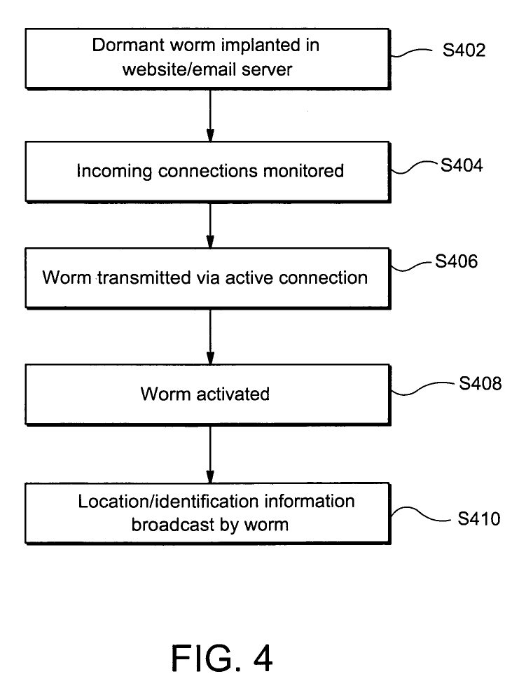

FIG. 4 is an illustrative flowchart showing a method of identifying and/or locating terrorists, in accordance with an example embodiment. In step S402, a worm is implanted in an online resource (e.g. a website, email server, etc.). As noted above, this implantation may be with the consent of the owner of the online resource, or it may be done surreptitiously. Incoming connections with client devices are monitored in step S404. When a connection between the online resource and a client device is established, the worm is transmitted via the active connection in step S406. After the worm has been transmitted to the client device, it is activated in step S408. The worm may cause location and/or identification information to be broadcast in step S410, for example, of the types and in the manners set forth above.

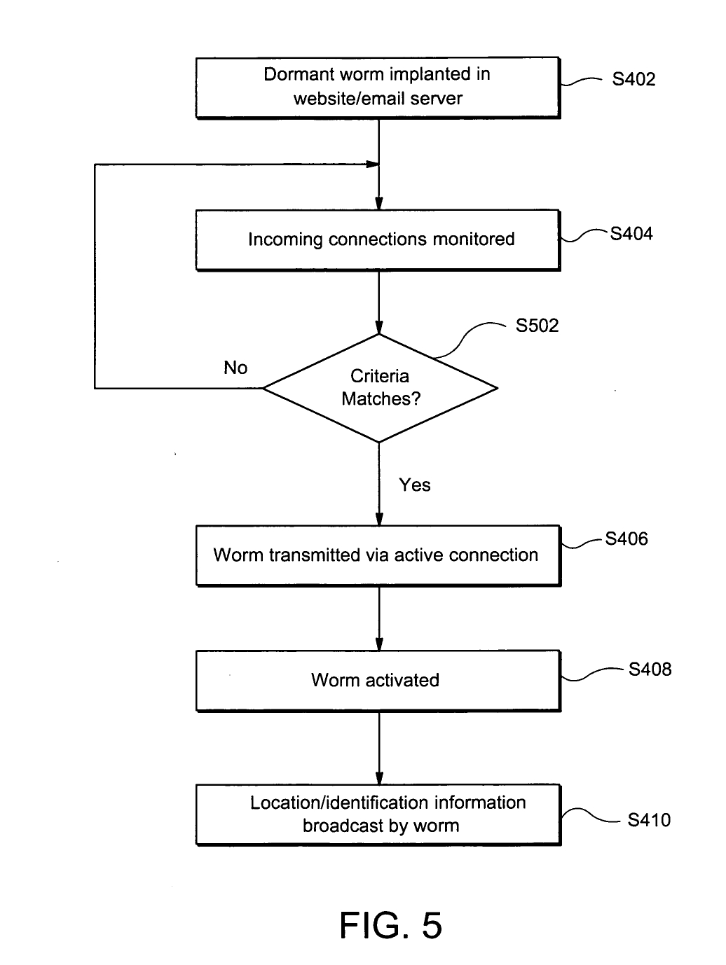

FIG. 5 is an illustrative flowchart showing another method of identifying and/or locating terrorists, in accordance with an example embodiment. FIG. 5 is like FIG. 4, except that it incorporates an additional step, step S502, to determine whether the incoming connection from the client device (as monitored in step S404) matches certain predetermined criteria. For example, step S502 may determine the originating IP address and/or port of the connection, the amount and/or type of information exchanged, etc. Another example would be content exchanged between or sent by the client device (e.g., if the content exchanged between or sent by the client device is terrorist related). If there is a match, the worm may be transmitted in step S406. However, if there is not a match, the process may be aborted for this transmission, and future incoming connections may be monitored in step S404.

Although the example embodiments herein have been described as relating to a worm, the present invention is not so limited. In particular, the term “worm” should be construed broadly to cover any software program capable of reproducing itself that can spread from one computer to the next over a network connection, or any module that can take advantage of file sending and receiving features found on computers and computerized systems. As used herein, the worm may comprise a series of executable codes, either in compiled form or suitable for interpretation and/or execution without having to be compiled. Thus, the worm may be a stand-alone program or simply a series of codes configured to cause one or more other programs and/or system resources to behave in a particular fashion.

Furthermore, although certain example embodiments have been described as relating to Internet and/or web connections, the present invention is not so limited. The example embodiments may be implemented on computer systems communicating over any computer-mediated network protocol. Also, the example embodiments may apply to more than the uploading, emailing, etc. of media. For example, they may be applicable whenever a terrorist-related website, email server, etc. is accessed.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of locating and/or identifying terrorists that use at least one client device to access a server device via a network, the method comprising:
storing a software module on the server device;
monitoring and/or permitting connections between the server device and the at least one client device;
transmitting the software module to the at least one client device in dependence on a determination of whether the connection between the server device and the at least one client device matches at least one of predefined criteria,
wherein, when the software module is received by the client device, the software module is configured to cause the client device broadcast or otherwise transmit a signal comprising location and/or identification information.

2. The method of claim 1, wherein the software module is a worm.

3. The method of claim 1, wherein the software module is stored on the server device and/or transmitted to the client device without server device owner's knowledge and/or without client device operator's knowledge.

4. The method of claim 1, wherein the client device comprises one or more of: a personal computer, a laptop, a PDA, a Blackberry, and/or a web-enabled cell phone.

5. The method of claim 1, wherein the network comprises the Internet.

6. The method of claim 1, wherein the predefined criteria comprises one or more of: an IP address of the client device, at least part of a network route associated with the connection between the client device and the server device, and/or content exchanged between or sent by the client device.

7. The method of claim 1, wherein the connection is associated with a file upload and/or email transmission from the client device.

8. The method of claim 1, wherein a worm is further configured to cause a GPS module operably connected to the client device to broadcast GPS coordinates associated with the client device so that the client device may be located.

9. The method of claim 1, wherein the signal includes one or more of: a processor serial number associated with a processor of the client device, an embedded ID of the client device, one or more components of the client device, GPS coordinates associated with the client device, a true IP address of the client device, and a true route between the client device and the server device.

10. The method of claim 1, further comprising providing an incentive for the terrorist to connect to the server device.

11. The method of claim 1, wherein the software module is configured to exploit one or more vulnerabilities of an operating system and/or programs running on the operating system of the client device.

12. The method of claim 1, wherein the signal is receivable at a monitored area.

13. The method of claim 1, further comprising positioning receivers for receiving said signal at one or more of airports, train stations and bus stations, so that the client device may be detected at such locations.

14. A software module configured to be stored on a server device and transmitted to at least one client device connecting to the server device, the software module comprising logic to cause the client device to broadcast a signal comprising location and/or identification information associated with the client device.

15. The software module of claim 14, wherein the software module comprises a worm.

16. The software module of claim 14, wherein the software module is stored on the server device and/or transmitted to the client device without server device owner's knowledge and/or without client device operator's knowledge.

17. The software module of claim 14, wherein the software module is transmitted based at least in part on predefined criteria, the predefined criteria including one or more of: an IP address of the at least one client device, at least part of a network route associated with the connection between the client device and the server device, and/or content which may be exchanged between the client device and server or sent to the server by the client device.

18. The software module of claim 14, wherein software module is further configured to cause a GPS module operably connected to the client device to broadcast GPS coordinates associated with the client device.

19. The software module of claim 14, wherein the signal includes one or more of: a processor serial number associated with a processor of the client device, an embedded ID of the client device, one or more components of the client device, GPS coordinates associated with the client device, a true IP address of the client device, and a true route between the client device and the server device.

20. The software module of claim 14, wherein the software module is configured to exploit one or more vulnerabilities of an operating system and/or programs running on the operating system of the client device.

21. The software module of claim 14, in combination with at least one receiver, wherein the receiver is for receiving said signal and is located at one or more of an airport and/or train station.
